(19) United States
(12) Patent Application Publication
(10) Pub. No.: US 2022/0256807 A1
(43) Pub. Date: Aug. 18, 2022

(54) ENCLOSURE FOR ANIMAL HUSBANDRY, FOR EXAMPLE FOR DAIRY CATTLE, COMPRISING A MILKING AREA PRECEDED BY A HOLDING AREA

(71) Applicant: GROUP ELASTOTECK, NORT SUR ERDRE (FR)

(72) Inventor: Jean-Vincent BIORET, PETIT MARS (FR)

(21) Appl. No.: 17/623,013

(22) PCT Filed: Jun. 25, 2020
(86) PCT No.: PCT/EP2020/067933

§ 371 Date: Dec. 27, 2021

(30) Foreign Application Priority Data
Jun. 27, 2019 (FR) 1907048

(51) Int. Cl. A01K 1/12; A01K 1/01

(52) U.S. Cl. CPC A01K 1/12; A01K 1/0103

(57) ABSTRACT

Disclosed is an enclosure for animal husbandry, for example for dairy cattle, including a milking area preceded by a holding area. The holding area is covered by a floor covering that is made from a material capable of undergoing elastic deformation and that includes a sloping top face intended as a support surface for the animals. The floor covering includes a system of pipes provided with several outlet openings that open at top face of the floor covering; and the enclosure includes a circulator connected to the system of pipes, for conveying a treatment liquid inside the system of pipes and for causing the treatment liquid to flow through the outlet openings.

### BACKGROUND OF THE INVENTION

### Field of the Invention

The present invention relates to the technical field of animal husbandry.

More particularly, it relates to enclosures for animal husbandry, for example for dairy cattle, including a milking area preceded by a holding area.

### Description of the Related Art

In most enclosures for animal husbandry, in particular for dairy cattle, the milking area is preceded by a holding area.

In this holding area, the animals are concentrated and their displacements are limited. The holding area hence actively contributes to the milking installation performance.

In particular, the holding area cleanliness will influence the animal behaviour. The dirtier and more confined the surface, the more likely the animals soil it and the more difficult the milking conditions.

For that purpose, it is advisable to scrape it after each milking and to wash at least the first meters between the milking room and the holding area.

Moreover, at the exit of the milking room, it is common to equip the return corridor with foot baths, that is to say trays filled with a disinfectant solution.

Such foot baths are normally provided for cattle's feet disinfection, in order to prevent infectious foot diseases (for example, foot-rot and Mortellaro disease).

But, in practice, the efficiency of these foot baths is not satisfying, and even deleterious.

A “new” disinfectant solution is indeed quickly soiled after the passage of only a few animals. The dirt then inhibits the disinfectant solution effect. Moreover, this soiled solution constitutes a new source of contamination for the following animals.

Implementing this foot bath solution also requires significant labour and maintenance, with the frequent replacement of the disinfectant solution accompanied with the cleaning of the tray.

Furthermore, the passage in such a foot bath is relatively brief, which does not allow an optimum action of the disinfectant solution.

There hence exists a need for a new technical solution for improving cattle condition is such a holding area.

### SUMMARY OF THE INVENTION

In order to remedy the above-mentioned drawback of the state of the art, the present invention proposes an enclosure for animal husbandry, for example for dairy cattle, including a milking area preceded by a holding area.

The holding area has two borders:
a downstream border, which is connected to said milking area (preferably through a step), and
an upstream border, which is connected to an area collecting the liquids flowing on the ground.

The holding area is covered with a flooring that is made of a material capable of undergoing an elastic deformation and that has an upper face intended to serve as a bearing surface for the animals.

The bearing surface has at least a downwardly sloping section from said downstream border to said upstream border, to favour the flowing of the fluids towards said liquid collection area.

And, according to the invention, the flooring includes a system of ducts provided with several outlets that open at the upper surface of the flooring.

And the enclosure comprises liquid circulation means that are connected to said system of ducts, for the travel of a treatment liquid within said system of ducts and for the flowing of said treatment liquid (possibly a non-foaming treatment liquid or a treatment liquid in the form of a liquid foam) through said outlets.

Implementing such a flooring in the holding area allows combining the advantages of a flexible ground (advantageously anti-skid/comfort) with the “foot bath” functionality.

This technical solution also avoids the labour usually linked to the management of a traditional foot bath.

It also improves the animal treatment as the holding area gathers the animals for a certain period of time; the treatment liquid can then be suitably deposited on the legs (contrary to a very short passage in a traditional foot bath).

The bearing surface, downwardly sloping, is moreover particularly simple to clean at each milking (again in comparison with a traditional foot bath).

According to a preferred embodiment, the outlets are distributed over the whole surface area of the upper face, advantageously along several longitudinal rows oriented perpendicular, or at least approximately perpendicular, to said downstream/upstream borders.

In this case, preferably, the system of ducts comprises several duct sections, oriented perpendicular, or at least approximately perpendicular, to said downstream/upstream borders, said duct sections each including several outlets, distributed over their length, to define one of said longitudinal rows; said system of ducts also advantageously including at least one transverse duct, oriented parallel, or at least approximately parallel, to said downstream/upstream borders; said at least one transverse duct including an inlet that is connected to said circulation means, and said at least one transverse duct being connected to said duct sections.

Still in this case, along each longitudinal row, the outlets advantageously have a centre-to-centre spacing from 100 to 1000 mm.

According to a preferred embodiment, the upper face of the flooring includes:
bearing strips, intended to serve as the bearing surface itself for the animals, and
longitudinal grooves, each separating two juxtaposed bearing strips,

said bearing strips and longitudinal grooves being oriented perpendicular, or at least approximately perpendicular, to said downstream/upstream borders.

Preferably, the outlets open into the longitudinal grooves.

Still preferably, the duct sections consist in tubes added in the longitudinal grooves, or the duct sections are formed within said flooring, underlying a bottom of said grooves, with the outlets extending between a duct section and the overlying bottom.

The grooves advantageously each have:
a width from 15 to 50 mm, and
a depth from 15 to 50 mm, and

the bearing strips have a width from 50 to 500 mm.

Other non-limitative and advantageously features of the enclosure according to the invention, taken individually or according to all the technically possible combinations, are the following:
the circulation means comprise at least one pump, and/or dosing means, for injecting the treatment product into a liquid medium, said circulation means being associated with control means for piloting their operation;
the downward slope of the flooring is of 1 to 10%, preferably 3 to 7% (advantageously obtained by the slope of the ground under the flooring);
the milking area is followed by at least one return corridor that is also covered with said flooring.

The present invention also relates to a method for releasing a treatment liquid at the upper face of the flooring covering the holding area of an enclosure according to the invention.

The releasing method comprises a step of circulating said treatment liquid within said system of ducts to generate a flowing of said treatment liquid through the outlets of said system of ducts.

The circulation step is advantageously implemented before and/or during the presence of animals in said holding area.

The treatment liquid is chosen for example among the treatment liquids advantageously containing a bacterial suspension or a disinfectant liquid.

Preferably, the treatment liquid is chosen among the foaming treatment liquids; and the height of foam obtained at the upper face of the flooring is advantageously of 10 to 100 mm, preferably 25 to 50 mm.

Of course, the different features, alternatives and embodiments of the invention can be associated with each other according to various combinations, insofar as they are not incompatible with each other or exclusive from each other.

### BRIEF DESCRIPTION OF THE DRAWINGS

Moreover, various other features of the invention emerge from the appended description made with reference to the drawings that illustrate non-limitative embodiments of the invention and in which:

FIG. 1 is a general and schematic view showing, in elevation, a possible implantation within an enclosure for animal husbandry in which a milking area is preceded by a holding area;

FIG. 2 is a schematic perspective view of a holding area including a flooring according to the invention (with a partial and enlarged top view of the upper face of the flooring);

FIG. 3 is a general and schematic view showing, in elevation, the upper face of the flooring covering the ground of a holding area according to FIG. 2;

FIG. 4 is a schematic view of the same flooring, along a transverse and vertical sectional plane;

FIG. 5 is a partial and enlarged view of the flooring of FIG. 4, showing the detail V corresponding to a first embodiment;

FIG. 6 is a schematic view of the flooring, along a transverse and longitudinal sectional plane passing through a groove, corresponding to the plane VI illustrated in FIG. 5;

FIG. 7 is also a partial and enlarged view of the flooring of FIG. 4, showing the detail VII corresponding to a second embodiment;

FIG. 8 is a schematic view of the flooring, along a transverse and longitudinal sectional plane passing through a groove, corresponding to the plane VIII illustrated in FIG. 7.

It is to be noted that, in these figures, the structural and/or functional elements common to the different alternatives can have the same references.

### DESCRIPTION OF THE PREFERRED EMBODIMENTS

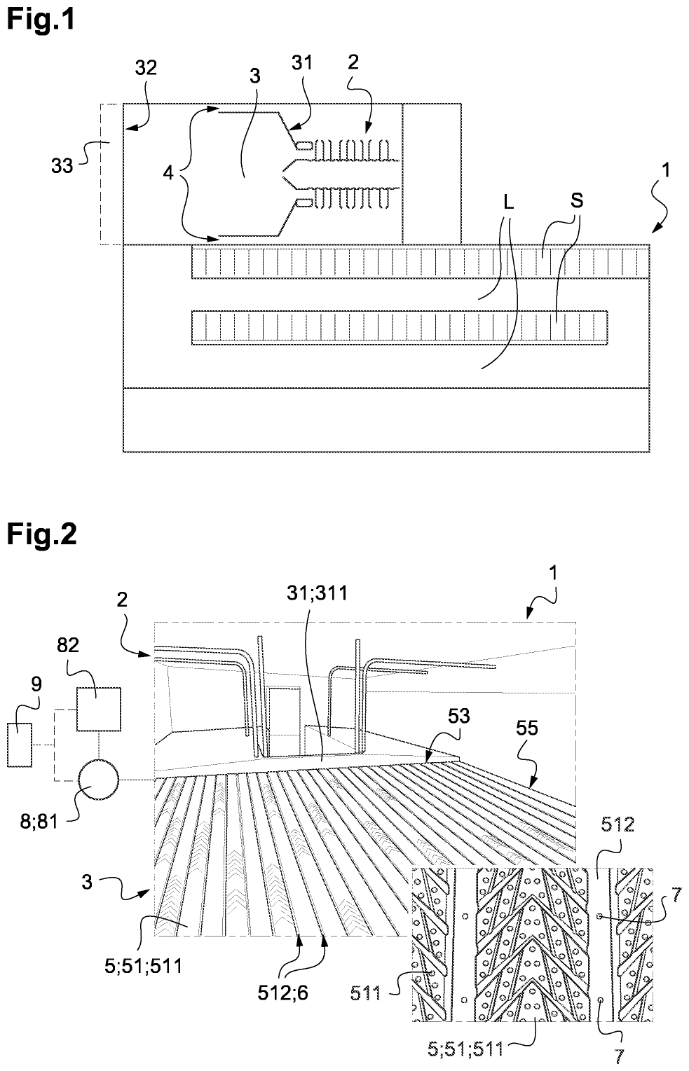

The enclosure 1 according to the invention, shown in particular in FIG. 1, consists of a building delimited by a frame and suitable for animal husbandry (for example, a stable in the case of cattle).

By “animals”, it is meant in particular cattle, in particular dairy cattle.

The enclosure 1 includes in particular a milking area 2 (also called “milking room”) preceded by a holding area 3. The milking area 2 can also be followed by at least one return corridor 4, possibly lining the holding area 3.

The holding area 3 is the area in which the animals are concentrated before entering progressively the milking area 2.

This enclosure 1 can also include other areas, i.e. for example at least one resting area S (in particular, eating areas or stalls) lined with a circulation corridor L.

The holding area 3 is shown in more detail in FIGS. 1 to 3.

This holding area 3 has two borders:
a downstream border 31, which is connected to the milking area 2, advantageously through a step 311 to be mounted (visible in FIG. 2), and
an upstream border 32, which is connected to a collection area 33 for collecting the liquids flowing on the ground (FIG. 1).

The ground 35 of this holding area 3 advantageously consists of a ground made of concrete or bitumen.

The upper face 351 of this ground 35 advantageously has at least a downwardly sloping section from the downstream border 31 to the upstream border 32, to favour the flowing of the liquids towards the collecting area 33.

This downward slope of the upper face 351 is preferably of 1 to 10%, preferably 3 to 7%.

Flooring

The upper face 351 of the ground 35 of the holding area 3 is covered by a flooring 5, which is added (for new or renovation).

The flooring 5 is made of a material capable of undergoing an elastic deformation and has an upper face 51 (advantageously with an anti-skid relief) intended to serve as a bearing surface for the animals.

This upper face 51 is advantageously adapted to undergo a sinking deformation, over at least 1 mm, and preferably between 1 and 5 mm, when supporting an animal's or a person's foot.

By “sinking”, it is meant in particular a reduction of thickness of the flooring 5.

For that purpose, the flooring 5 is advantageously made of at least one material capable of undergoing an elastic deformation, chosen among:
the elastomeric materials, i.e. for example the natural rubber, the “synthetic natural” rubber (or synthetic poly-isoprene), the polybutadiene or the styrene-budatiene, or
the plastic or thermoplastic elastomeric (TPE) materials, i.e. for example PVB (polyvinyl butyral), ABS (acrylonitrile butadiene styrene)/SBR (styrene-butadiene), PP (polypropylene)/EPDM (ethylene-propylene-diene monomer), TPU (TPE polyurethane).

This flooring 5 can be made of:
one material, or
multiple materials.

The upper face 51, also called “bearing surface”, has at least a downwardly sloping section from the downstream border 31 to the upstream border 32.

This slope is here defined by the upper face 351 of the ground 35, to favour the flowing of the fluids towards the collection area 33.

The downward slope of the flooring 5, and in particular its upper face 51, is advantageously of 1 to 10%, preferably 3 to 7%.

More generally, this flooring 5 has two opposite faces, defining the thickness thereof, i.e.:
the above-mentioned upper face 51, and
a lower face 52, bearing on the upper face 351 of the ground 35.

The opposite faces 51, 52 advantageously extend parallel to each other.

The thickness of the flooring 5 is for example of 10 to 80 mm, preferably 20 to 30 mm.

This flooring 5 also includes two couples of edges:
two transverse edges, a downstream one 53 coming on the side of the downstream border 31 (side of the milking area 2) and an upstream one 54 coming on the side of the upstream border 32 (side of the collecting area 33), and
two longitudinal edges 55.

The contour of this flooring 5 advantageously corresponds to the contour of the holding area 3 and, preferably, as the case may be, to at least one return corridor 4 present at the exit of the milking area 2.

The flooring 5 also advantageously integrates at least one armouring layer 56, also called “reinforcement sub-layer”.

The reinforcement sub-layer 56 is advantageously chosen among the textile fibres, the metal fibres or any other product providing stability and/or resistance to elongation.

This reinforcement sub-layer 56 consists for example of a textile insert serving as a reinforcement, advantageously made of a material chosen among nylon, cotton, polyester, polyamide or any other reinforcement textile.

According to the invention, the enclosure 1 includes an equipment/system using the flooring 5 covering the holding area 3 (and potentially at least one return corridor 4), for the release of a treatment liquid at the upper face 51 of this flooring 5.

By “treatment liquid”, it is advantageously meant the treatment liquids containing a bacterial suspension or a disinfectant liquid.

This treatment liquid may consist of a liquid added with at least one bacterial strain. Said at least one bacterial strain is advantageously chosen among the bacterial strains capable of colonizing the animals' legs.

In the case of a treatment liquid including such bacteria, said at least one bacterial strain (or a mixture of bacterial strains) is advantageously chosen among the “favourable”, “positive” or prophylactic bacterial strains, capable of colonizing the animals' legs, which will naturally seed the whole stable during their displacements.

Said at least one bacterial strain is advantageously capable of forming a seeding flora that guides the “positive” fermentations.

“Positive fermentation” encompasses one at least of the following phenomena:
ammonia capture and fixation as organic nitrogen,
reduction of GHGs and gases harmful to animal health,
modification of the medium,
beneficial fermentation for accelerated litter recovery.

The bacterial strain consists for example of a lyophilized bacterial complex belonging to the groups of lactic bacteria and Bacillus subtilis.

The treatment liquid is a non-foaming liquid or, more advantageously, a foaming liquid, hence forming a “foaming treatment liquid” or a “treatment liquid in the form of a liquid foam”.

A liquid foam is consisted of an abundance of gas bubbles separated by a liquid that forms a continuous phase. For an aqueous solution, it is also possible to talk about an aqueous foam.

For that purpose, the treatment liquid can also contain foaming agents or foaming excipients, conventional per se, which are chosen among the acceptable compounds for use in a husbandry enclosure and for a contact with the animals' feet.

The liquid foam is formed, preferably, when the treatment liquid is released at the upper face 51 of this flooring 5.

The repetition of this release operation, advantageously with an adapted periodicity, further makes it possible to colonize and saturate the ground with “favourable” bacteria and to keep the development of the “unfavourable” bacteria at levels that are not harmful for the animals.

For that purpose, the flooring 5 includes a system of ducts 6 provided with several outlets 7 that open at the upper face 51 of this flooring 5, for the release of the treatment liquid at this latter surface.

The outlets 7 advantageously have a vertical, or at least approximately vertical, longitudinal axis.

In other words, the outlets 7 advantageously each have a longitudinal axis that is perpendicular to the upper face 51, or to the general plane, of the flooring 5.

Each outlet 7 advantageously ensures an upward, ascending release of the treatment liquid, from the system of ducts 6 to the upper face 51 of the flooring 5.

For an optimum distribution of the treatment liquid, the outlets 7 are advantageously distributed over the whole surface area of the upper face 51 of the flooring 5.

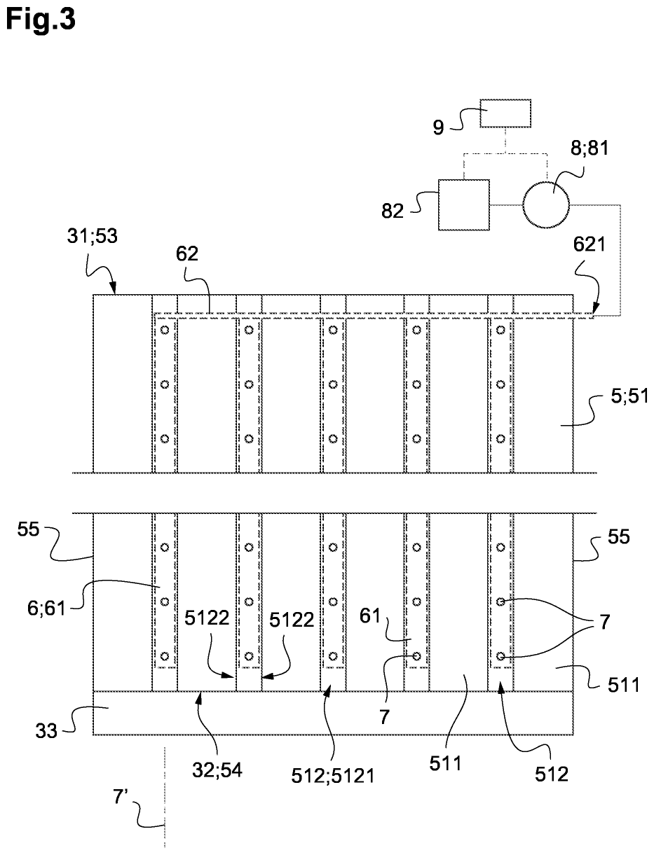

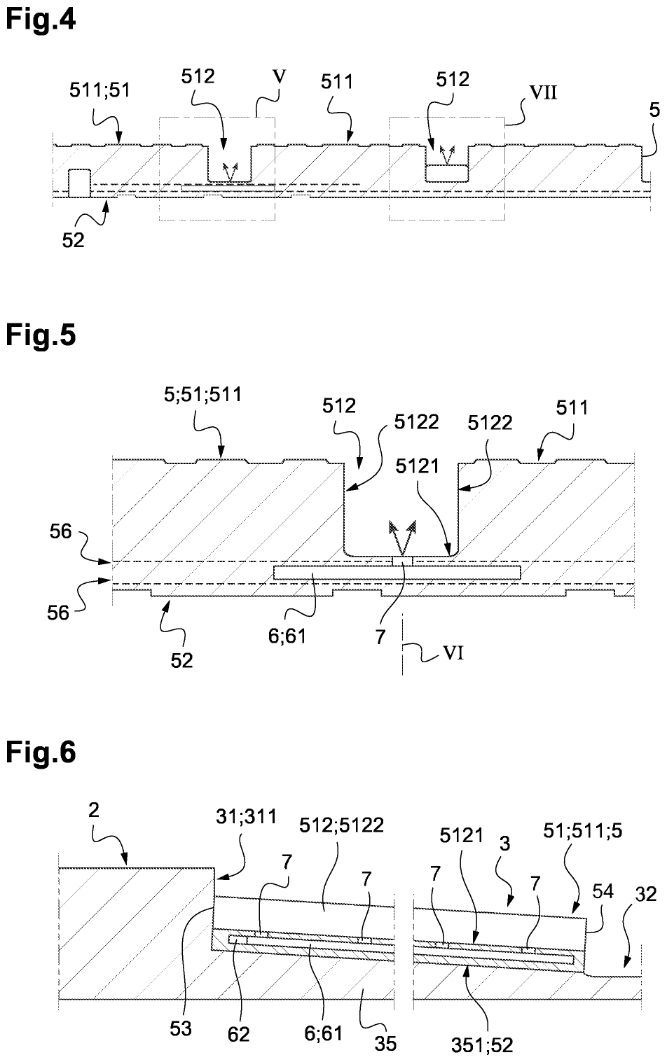

Still preferably, the outlets 7 are distributed along several longitudinal rows 7′ (or longitudinal straight lines) that are oriented perpendicular, or at least approximately perpendicular, to the downstream 31/upstream 32 borders (FIG. 3). In other words, these longitudinal rows 7′ are oriented parallel to the longitudinal edges 55.

Along each longitudinal row 7′, the outlets 7 advantageously have a centre-to-centre spacing from 100 to 1000 mm.

The outlets 7 further advantageously include, under pressure, a diameter lower than 0.2 to 3 mm, preferably 0.5 to 1.5 mm.

For that purpose, the system of ducts 6 here comprises several (longitudinal) duct sections 61, which are oriented perpendicular, or at least approximately perpendicular, to the above-mentioned downstream 31/upstream 32 borders. In other words, these duct sections 61 are oriented parallel to the longitudinal edges 55 of the flooring 5.

Each duct section 61 includes several outlets 7, distributed over its length, to define one of the longitudinal rows 7′.

The system of ducts 6 also advantageously includes at least one transverse duct 62 that is connected to the above-mentioned duct sections 61, for supplying these latter with the treatment liquid.

This transverse duct 62 is oriented parallel, or at least approximately parallel, to the downstream 31/upstream 32 borders. In other words, this transverse duct 62 is oriented parallel to the transverse edges 53, 54.

Said at least one transverse duct 62 is advantageously arranged along a transverse edge 53, 54 of the flooring 5 (for example, the downstream transverse edge 53).

Said at least one transverse duct 62 includes an inlet 621 that is connected to circulation means 8 that will be described hereinafter.

In the different embodiments described in relation with the figures, the upper face 51 of the flooring 5 here includes a bearing strips 511/longitudinal grooves 512 unit cooperating with the system of ducts 6.

More precisely, the upper face 51 includes:
bearing strips 511, intended to serve as the bearing surface itself for the animals, and
longitudinal grooves 512, each separating two juxtaposed bearing strips 511.

The bearing strips 511 and longitudinal grooves 512 are oriented perpendicular, or at least approximately perpendicular, to said downstream 31/upstream 32 borders of the holding area 3.

In other words, these bearing strips 511 and longitudinal grooves 512 are oriented parallel to the longitudinal edges 55 of the flooring 5.

Herein, the longitudinal grooves 512 are defined by different longitudinal walls:
a bottom wall 5121, also called “bottom”, and
two lateral walls 5122, on either side of the bottom 5121.

The longitudinal grooves 512 each advantageously have:
a width (distance between the lateral walls 512) from 15 to 50 mm, and
a depth (height of the lateral walls 512) from 15 to 50 mm.

Moreover, the bearing strips 511 each have a width from 50 to 500 mm.

In these embodiments with “longitudinal grooves”, the outlets 7 advantageously open into the longitudinal grooves 512.

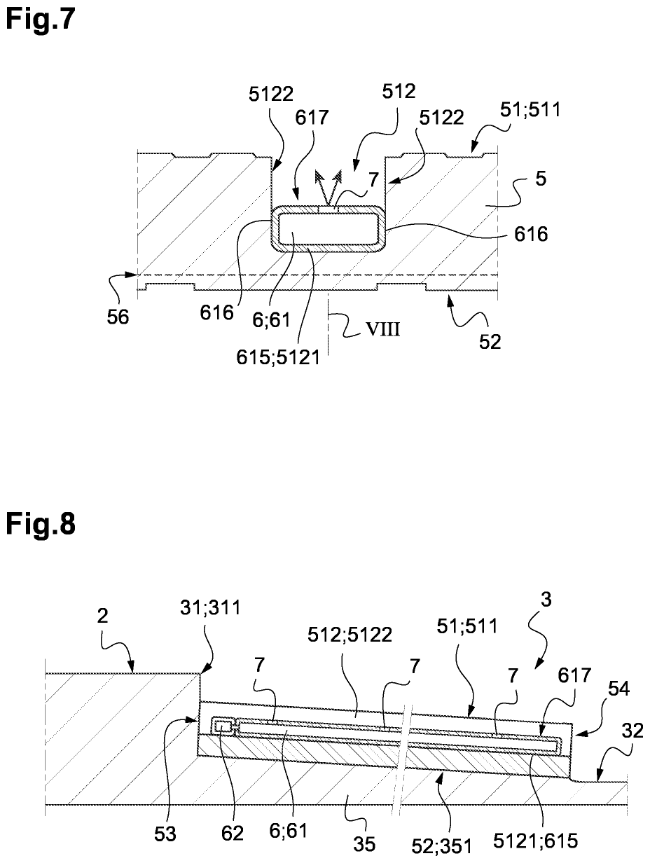

More precisely, two embodiments are illustrated here:
the duct sections 61 are arranged within the flooring 5, underlying the bottom 5121 of the grooves 512, with the outlets 7 extending between a duct section 61 and the underlying bottom 5121, forming a “one-piece flooring” embodiment (FIGS. 5 and 6), or
the duct sections 61 consist of tubes that are added (also said “deposited”) in the longitudinal grooves 512, forming an “added flooring” embodiment (FIGS. 7 and 8).

In the “one-piece flooring” embodiment, the duct sections 61 are advantageously arranged between the armouring layers 56 (FIG. 5), in such a way as to provide optimum mechanical strength to these duct sections 61.

The outlets 7 then pass through the (upper) armouring layer 56 located between the duct sections 61 and the bottom 5121 of the grooves 512.

The transverse duct 62 then preferably consists of a polyethylene feeder or a galvanized metal (preferably stainless steel) feeder.

In the “added flooring” embodiment, the tubes 61 are advantageously made of a plastic material or a metal material, for example a microperforated plastic or rubber tube, or a stainless steel tube equipped with foaming nozzles.

These tubes 61 have advantageously a rectangular section, with:
a lower wall 615, for bearing on the bottom 5121 of a groove 512,
two lateral walls 616, in order to be laterally blocked between the lateral walls 5122 of this same groove 512, and
an upper wall 617, here provided with outlets 7.

These tubes 61 have advantageously a height (distance between its lower 615/upper 617 walls) that is lower than the depth of the longitudinal groves 512, in such a way as to avoid a direct contact with the animals' feet.

The transverse duct 62 then preferably consists of a polyethylene feeder or a galvanized metal (preferably stainless steel) feeder.

In practice, generally, the flooring 5 is added on and fastened to the ground 35 of the folding are 3. This flooring 5 be in the form of a plate or a roll to be unwound.

For the diffusion of the treatment liquid, the enclosure 1 also comprises liquid circulation means 8 that are connected to the system of ducts 6 (and in particular to the transverse duct 62).

The liquid circulation means 8 are adapted for the travel of the treatment liquid within the system of ducts 6 and to the flowing (also called “diffusion”) of this treatment liquid through the outlets 7.

For that purpose, the circulation means 8 comprise:
at least one pump 81, and/or
dosing means 82, for injecting the treatment product into a liquid medium.

Said at least one pump 81 is advantageously chosen in such a way as to obtain a pressure of 0.4 to 2 bars in the system of ducts 6.

The dosing means 82 consist for example of a dosing unit, advantageously hydraulic, for a dosing proportional to the flow of water passing through the dosing unit.

The circulation means 8 are also advantageously associated with control means 9, advantageously an industrial programmable automaton, to pilot the operation thereof.

This operation of the circulation means 8, and in particular the pump 81, is advantageously cyclic.

The control means 9, conventional per se, hence regulate the duration and frequency of operation of the circulation means 8 for each milking cycle.

For example, the control means 9 can control:
the starting of the circulation means 8 at the beginning of the milking (for example, after a manual triggering), then
the keeping in operation of the circulation means 8 all along this milking (for example automatically, continuously or discontinuously).

The delivered quantity depends on the number of cows and on the concentration in active material.

For example, 20 to 50 L of treatment liquid (as a function of its dilution) can be delivered during a milking cycle, for 50 cows.

Method for Releasing the Treatment Liquid

The present invention also relates to a method for releasing a treatment liquid at the upper face 51 of the flooring 5 covering the holding area 3.

This releasing method comprises a step of circulating the treatment liquid within the system of ducts 6 to generate a flowing of the treatment liquid through the outlets 7 of this system of ducts 6.

This circulation step is advantageously implemented at least during the presence of animals in the holding area 3 (or even previously to the arrival of the animals), via the circulation means 8 and the control means 9.

For that purpose, the treatment liquid is sprayed/diffused through the outlets 7 (advantageously continuously or discontinuously).

This treatment liquid must then diffuse at the upper face 51 (here, out of the grooves 512), to reach the animals' feet (advantageously over a height of 10 to 100 mm, preferably 25 to 50 mm) and/or to reach the bearing strips 511.

In the case of foaming treatment liquids, the height of foam obtained at the upper face 51 of the flooring 5 is advantageously of 10 to 100 mm, preferably 25 to 50 mm.

Moreover, the slope of the upper face 51 of the flooring 5 allows a flowing by gravity of the treatment liquid towards the collection area 33.

During the waiting period, the diffusion of the treatment liquid (continuous or discontinuous) hence allows its renewal and replacement by a new treatment liquid, all along the presence of the animals in the holding area 3.

Hence, the feet of the animals present in the holding area 3 are custom treated with a “clean” treatment liquid.

Moreover, at the end of the treatment, the treatment liquid is evacuated by gravity towards the collection area 33; the bearing strips 511 moreover remain relatively dry. These elements contribute to ensure good sanitary conditions for the animals in this holding area 3.

Likewise, the treatment liquid can be diffused within said at least one return corridor 4. The feet of the animals circulating in said at least one return corridor 4 can hence also be custom treated.

The release method can be implemented to diffuse the treatment liquid exclusively (or solely or only) for treating the ground (advantageously a non-therapeutical treatment).

For example, with the treatment liquids containing a bacterial suspension, the repetition of this release operation, advantageously with a suitable periodicity, makes it possible to colonize and saturate the ground with “favourable” bacteria and to maintain the development of the “unfavourable” bacteria at levels that are not harmful for the animals.

The diffusion of a treatment liquid chosen among the disinfectant liquids itself allows disinfecting the ground.

As explained hereinabove, this solution provides many advantages, in particular combining the advantages of a flexible ground (advantageously anti-skid/comfort), with the “foot bath” functionality.

1. An enclosure for animal husbandry, including a milking area preceded by a holding area,
said holding area including two borders:
a downstream border, which is connected to said milking area, and
an upstream border, which is connected to an area collecting the liquids flowing on the ground,
said holding area being covered with a flooring that is made of a material capable of undergoing an elastic deformation and that has an upper face intended to serve as a bearing surface for the animals,
said upper face having at least a downwardly sloping section from said downstream border to said upstream border, to favour the flowing of the fluids towards said liquid collection area,
wherein said flooring includes a system of ducts provided with several outlets that open at the upper face of said flooring, and
said enclosure comprising circulation means that are connected to said system of ducts, for the travel of a treatment liquid within said system of ducts and for the flowing of said treatment liquid through said outlets.

2. The enclosure for animal husbandry according to claim 1, wherein the outlets are distributed over the whole surface area of the upper face.

3. The enclosure for animal husbandry according to claim 2, wherein the outlets are distributed over the whole surface area of the upper face, along several longitudinal rows oriented perpendicular, or at least approximately perpendicular, to said downstream/upstream borders.

4. The enclosure for animal husbandry according to claim 2, wherein the system of ducts comprises several duct sections that are oriented perpendicular, or at least approximately perpendicular, to said downstream/upstream borders,
said duct sections each including several outlets, distributed over a length of the duct section, to define one of said longitudinal rows.

5. The enclosure for animal husbandry according to claim 2, wherein, along each longitudinal row, the outlets have a centre-to-centre spacing from 100 to 1000 mm.

6. The enclosure for animal husbandry according to claim 1, wherein the upper face of the ground includes:
bearing strips, intended to serve as the bearing surface itself for the animals, and
longitudinal grooves, each separating two juxtaposed bearing strips,
said bearing strips and longitudinal grooves being oriented perpendicular, or at least approximately perpendicular, to said downstream/upstream borders.

7. The enclosure for animal husbandry according to claim 6, wherein the outlets open into the longitudinal grooves.

8. The enclosure for animal husbandry according to claim 7, wherein the system of ducts comprises several duct sections that are oriented perpendicular, or at least approximately perpendicular, to said downstream/upstream borders,
said duct sections each including several outlets, distributed over a length of the duct section, to define one of said longitudinal rows
and wherein:
the duct sections consist of tubes added in the longitudinal grooves, or
the duct sections are formed within said flooring, underlying a bottom of said longitudinal grooves, with the outlets extending between a duct section and the overlying bottom.

9. The enclosure for animal husbandry according to claim 6, wherein the longitudinal grooves each have:
a width from 15 to 50 mm, and
a depth from 15 to 50 mm, and
and wherein the bearing strips have a width from 50 to 500 mm.

10. The enclosure for animal husbandry according to claim 1, wherein the circulation means comprise:
at least one pump, and/or
dosing means, for injecting the treatment product into a liquid medium,
said circulation means being associated with control means to pilot the operation thereof.

11. A method for releasing a treatment liquid at the upper face of the flooring covering the holding area of an enclosure according to claim 1,
said releasing method comprising a step of circulating said treatment liquid within said system of ducts to generate a flowing of said treatment liquid through outlets of said system of ducts.

12. The method for releasing a treatment liquid according to claim 11, wherein the treatment liquid is chosen among the treatment liquids containing a bacterial suspension or a disinfectant liquid.

13. The method for releasing a treatment liquid according to claim 11, wherein the treatment liquid is chosen among the foaming treatment liquids.

14. The method of claim 11, wherein said circulation step is implemented before and/or during the presence of animals in said holding area.

15. The method of claim 13, wherein the height of foam obtained at the upper face of the flooring is 10 to 100 mm.

16. The method of claim 14, wherein the height of foam obtained at the upper face of the flooring is 10 to 100 mm.

17. The method of claim 13, wherein the height of foam obtained at the upper face of the flooring is 25 to 50 mm.

18. The method of claim 14, wherein the height of foam obtained at the upper face of the flooring is 25 to 50 mm.

19. The enclosure for animal husbandry according to claim 3, wherein the system of ducts comprises several duct sections that are oriented perpendicular, or at least approximately perpendicular, to said downstream/upstream borders,
said duct sections each including several outlets, distributed over a length of the duct section, to define one of said longitudinal rows.

20. The enclosure for animal husbandry according to claim 3, wherein, along each longitudinal row, the outlets have a centre-to-centre spacing from 100 to 1000 mm.
